(19) United States
(12) Patent Application Publication
(10) Pub. No.: US 2020/0121147 A1
(43) Pub. Date: Apr. 23, 2020

(54) VACUUM CLEANER

(71) Applicant: TOSHIBA LIFESTYLE PRODUCTS & SERVICES CORPORATION, Kawasaki-shi, Kanagawa (JP)

(72) Inventors: Hirokazu IZAWA, Aisai (JP); Yuuki MARUTANI, Nagakute (JP); Kota WATANABE, Owariasahi (JP)

(73) Assignee: TOSHIBA LIFESTYLE PRODUCTS & SERVICES CORPORATION, Kawasaki-shi, Kanagawa (JP)

(21) Appl. No.: 16/604,583

(22) PCT Filed: May 22, 2018
(86) PCT No.: PCT/JP2018/019640

§ 371 Date: Oct. 11, 2019

(30) Foreign Application Priority Data
May 23, 2017 (JP) 2017-101944

(51) Int. Cl. A47L 9/28; G05D 1/02

(52) U.S. Cl. CPC A47L 9/2852; G05D 1/0246; A47L 9/2805; G05D 2201/0215; A47L 2201/04; A47L 9/2873; A47L 2201/022

(57) ABSTRACT

A vacuum cleaner includes a main casing, a driving wheel, a control unit, a camera, a self-position estimation part, an obstacle detection part, and a mapping part. The camera captures an image in a traveling direction side of the main casing. The self-position estimation part estimates a position of the main casing on a basis of the image captured by the camera. The obstacle detection part detects an obstacle on a basis of the image captured by the camera. A timing in which either of processing by the self-position estimation part or processing by the obstacle detection part is executed during the main casing's traveling, as well as a timing when the both types of processing are executed simultaneously during the same, are set. The vacuum cleaner can autonomously traveling while reducing a load of image processing.

### TECHNICAL FIELD

Embodiments described herein relate generally to a vacuum cleaner including a self-position estimation part for estimating a position of a main body, an obstacle detection part for detecting an obstacle, and a mapper for generating a map of a traveling area, and each part performs the processing thereof on the basis of the images captured by a camera.

### BACKGROUND ART

Conventionally, a so-called autonomously-traveling type vacuum cleaner (a cleaning robot) has been known, which cleans a floor surface as a cleaning-object surface while autonomously traveling on the floor surface.

A technology for performing efficient cleaning by such a vacuum cleaner is provided, by which a map is generated (through mapping) by reflecting the size and shape of a room to be cleaned, and an obstacle or the like on the map, and thereafter an optimum traveling route is set on the basis of the map so that the vacuum cleaner travels along the traveling route. In an example, such a map is generated on the basis of the images of a ceiling or the like captured by use of the camera disposed on the upper portion of a main casing.

On the other hand, when the vacuum cleaner travels during the cleaning, in order to surely complete the cleaning, the vacuum cleaner needs to travel on the basis of the generated map as described above while avoiding an obstacle (such as legs of a table or a bed or the like, furniture, a step gap, or the like) in a cleaning area. In the case where the vacuum cleaner travels while detecting an obstacle as described above, the simultaneous execution of such map generation and such self-position estimation increases a load of image processing.

### CITATION LIST

### Patent Literature

PTL 1: Patent publication No. 5426603

### SUMMARY OF INVENTION

### Technical Problem

The technical problem to be solved by the present invention is to provide a vacuum cleaner capable of surely autonomously traveling while reducing a load of image processing.

### Solution to Problem

A vacuum cleaner according to an embodiment has a main body, a travel driving part, a controller, a camera, a self-position estimation part, an obstacle detection part, and a mapper. The travel driving part allows the main body to travel. The controller makes the main body travel autonomously by controlling driving of the travel driving part. The camera captures an image in a traveling direction side of the main body. The self-position estimation part estimates a position of the main body on the basis of the image captured by the camera. The obstacle detection part detects an obstacle on the basis of the image captured by the camera. The mapper generates a map of a traveling area on the basis of the image captured by the camera, the position of the main body estimated by the self-position estimation part, and the obstacle detected by the obstacle detection part. Further, a timing in which either of each processing by the self-position estimation part or the obstacle detection part is executed during the main body's travelling, as well as a timing in which both of the processing are simultaneously executed during the same, are set.

### BRIEF DESCRIPTION OF DRAWINGS

FIG. 1 is a block diagram illustrating a vacuum cleaner according to one embodiment;

FIG. 2 is a perspective view illustrating a vacuum cleaning system including the vacuum cleaner;

FIG. 3 is a plan view illustrating the vacuum cleaner as viewed from below;

FIG. 4 is an explanatory view schematically illustrating the vacuum cleaning system including the vacuum cleaner;

FIG. 5 is an explanatory view schematically illustrating a method of calculating a distance to an object by use of cameras of the vacuum cleaner;

FIG. 6(a) is an explanatory view schematically illustrating one example of the image captured by one camera, and the image processing range thereof, and FIG. 6(b) is an explanatory view schematically illustrating one example of the image captured by the other camera, and the image processing range thereof;

FIG. 7 is an explanatory view schematically illustrating the respective timings of the processing by a self-position estimation part of the vacuum cleaner as well as of the processing by an obstacle detection part thereof; and

FIG. 8 is an explanatory view illustrating one example of a map generated by a mapper of the vacuum cleaner.

### DESCRIPTION OF EMBODIMENT

The configuration of one embodiment is described below with reference to the drawings.

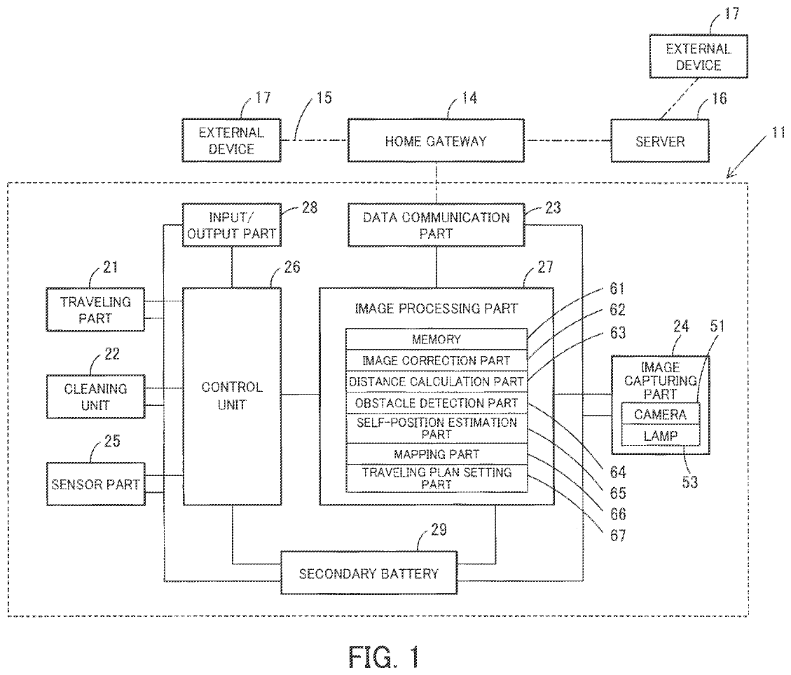

In FIG. 1 to FIG. 4, reference sign 11 denotes a vacuum cleaner as an autonomous traveler. The vacuum cleaner 11 constitutes a vacuum cleaning apparatus (a vacuum cleaning system) serving as an autonomous traveler device in combination with a charging device (a charging table) 12 serving as a station device corresponding to a base station for charging the vacuum cleaner 11. In the present embodiment, the vacuum cleaner 11 is a so-called self-propelled robot cleaner (a cleaning robot), which autonomously travels (self-travels) on a floor surface that is a cleaning-object surface as a traveling surface while cleaning the floor surface. In an example, the vacuum cleaner 11 is capable of performing wired or wireless communication via a (an external) network 15 such as the Internet or the like with a general-purpose server 16 serving as data storage means (a data storage section), a general-purpose external device 17 serving as a display terminal (a display part), or the like by performing communication (transmission/reception of data) with a home gateway (a router) 14 serving as relay means (a relay part) disposed in a cleaning area or the like by using wired communication or wireless communication such as Wi-Fi (registered trademark), Bluetooth (registered trademark), or the like.

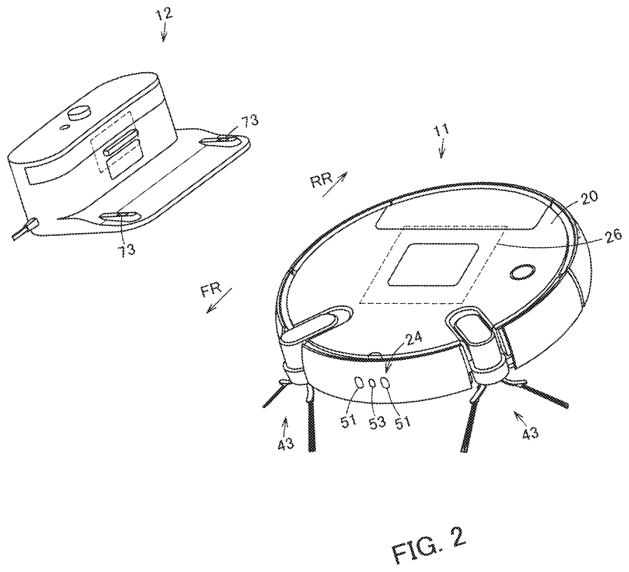

The vacuum cleaner 11 includes a main casing 20 which is a hollow main body. The vacuum cleaner 11 further includes a traveling part 21. The vacuum cleaner 11 further includes a cleaning unit 22 for removing dust and dirt. The vacuum cleaner 11 further includes a data communication part 23 serving as data communication means serving as information transmitting means for performing wired communication or wireless communication via the network 15. The vacuum cleaner 11 further includes an image capturing part 24 for capturing images. The vacuum cleaner 11 further includes a sensor part 25. The vacuum cleaner 11 further includes a control unit 26 serving as control means which is a controller. The vacuum cleaner 11 further includes an image processing part 27 serving as image processing means which is a graphics processing unit (GPU). The vacuum cleaner 11 further includes an input/output part 28 with which signals are input and output between an external device. The vacuum cleaner 11 includes a secondary battery 29 which is a battery for power supply. It is noted that the following description will be given on the basis that a direction extending along the traveling direction of the vacuum cleaner 11 (the main casing 20) is treated as a back-and-forth direction (directions of an arrow FR and an arrow RR shown in FIG. 2), while a left-and-right direction (directions toward both sides) intersecting (orthogonally crossing) the back-and-forth direction is treated as a widthwise direction.

The main casing 20 is formed of, for example, synthetic resin or the like. The main casing 20 may be formed into, for example, a flat columnar shape (a disk shape) or the like. The main casing 20 may have a suction port 31 or the like which is a dust-collecting port, in the lower part or the like facing the floor surface.

The traveling part 21 includes driving wheels 34 serving as a travel driving part. The traveling part 21 further includes motors not shown which correspond to driving means for driving the driving wheels 34. That is, the vacuum cleaner 11 includes the driving wheels 34 and the motors for driving the driving wheels 34. It is noted that the traveling part 21 may include a swing wheel 36 for swinging or the like.

The driving wheels 34 are used to make the vacuum cleaner 11 (the main casing 20) travel (autonomously travel) on the floor surface in the advancing direction and the retreating direction. That is, the driving wheels 34 serve for traveling use. In the present embodiment, a pair of the driving wheels 34 is disposed, for example, on the left and right sides of the main casing 20. It is noted that a crawler or the like may be used as a travel driving part instead of these driving wheels 34.

The motors are disposed to correspond to the driving wheels 34. Accordingly, in the present embodiment, a pair of the motors is disposed on the left and right sides, for example. The motors are capable of independently driving each of the driving wheels 34.

The cleaning unit 22 is configured to remove dust and dirt on a cleaning-object part, such as a floor surface, a wall surface or the like. In an example, the cleaning unit 22 has the function of collecting and catching dust and dirt on a floor surface through the suction port 31, and/or wiping a wall surface. The cleaning unit 22 may include at least one of an electric blower 40 for sucking dust and dirt together with air through the suction port 31, a rotary brush 41 serving as a rotary cleaner rotatably attached to the suction port 31 to scrape up dust and dirt and a brush motor for rotationally driving the rotary brush 41, side brushes 43 which correspond to auxiliary cleaning means (auxiliary cleaning parts) serving as swinging-cleaning parts rotatably attached on both sides of the front side of the main casing 20 or the like to scrape up dust and dirt as well as side brush motors for driving the side brushes 43. The cleaning unit 22 may further include a dust-collecting unit which communicates with the suction port 31 to accumulate dust and dirt.

The data communication part 23 is, for example, a wireless LAN device for exchanging various types of information with the external device 17 via the home gateway 14 and the network 15. It is noted that the data communication part 23 may have an access point function so as to perform direct wireless communication with the external device 17 without the home gateway 14. The data communication part 23 may additionally have, for example, a web server function.

The image capturing part 24 includes a camera 51 serving as image capturing means (an image-pickup-part main body). That is, the vacuum cleaner 11 includes the camera 51. The image capturing part 24 may include a lamp 53 serving as illumination means (an illumination part) for providing illumination for the camera 51. That is, the vacuum cleaner 11 may include the lamp 53.

The camera 51 is a digital camera for capturing digital images of the forward direction which is the traveling direction of the main casing 20 at a specified horizontal angle of view (such as 105 degrees) and at a specified frame rate. The camera 51 may be configured as one camera or as plural cameras. In the present embodiment, a pair of the cameras 51 is disposed on the left and right sides. That is, the cameras 51 are disposed apart from each other on the left side and the right side of the front portion of the main casing 20. The cameras 51, 51 have image ranges (fields of view) overlapping with each other. Accordingly, the image ranges of the images captured by these cameras 51, 51 overlap with each other in the left-and-right direction. It is noted that the camera 51 may capture, for example, a color image or a black/white image in a visible light region, or an infrared image. The image captured by the camera 51 may be compressed into a specified data format by, for example, the image processing part 27 or the like.

The lamp 53 is configured to emit light for illumination at the time when the cameras 51 capture images. In the present embodiment, the lamp 53 is disposed at an intermediate portion between the cameras 51, 51. The lamp 53 is configured to emit light according to the wavelength range of the light to be captured by the cameras 51. Accordingly, the lamp 53 may radiate light containing visible light region, or may radiate infrared light.

The sensor part 25 is configured to sense various types of information to be used to support the traveling of the vacuum cleaner 11 (the main casing 20). More specifically, the sensor part 25 is configured to sense, for example, pits and bumps (a step gap) of the floor surface, a wall that would be an obstacle to traveling, an obstacle, or the like. That is, the sensor part 25 includes a step gap sensor, an obstacle sensor or the like such as an infrared sensor or a contact sensor. It is noted that the sensor part 25 may further include a rotational speed sensor such as an optical encoder for detecting rotational speed of each of the driving wheels 34 (each motor) to detect a swing angle and a traveling distance of the vacuum cleaner 11 (the main casing 20), a dust-and-dirt amount sensor such as an optical sensor or the like for detecting an amount of dust and dirt on the floor surface, or the like.

For example, a microcomputer including a CPU corresponding to a control means main body (a control unit main body), a ROM, and a RAM or the like is used as the control unit 26. The control unit 26 includes a travel control part not shown, which is electrically connected to the traveling part 21. The control unit 26 further includes a cleaning control part not shown, which is electrically connected to the cleaning unit 22. The control unit 26 further includes a sensor connection part not shown, which is electrically connected to the sensor part 25. The control unit 26 further includes a processing connection part not shown, which is electrically connected to the image processing part 27. The control unit 26 further includes an input/output connection part not shown, which is electrically connected to the input/output part 28. That is, the control unit 26 is electrically connected to the traveling part 21, the cleaning unit 22, the sensor part 25, the image processing part 27 and the input/output part 28. The control unit 26 is further electrically connected to the secondary battery 29. The control unit 26 includes, for example, a traveling mode for driving the driving wheels 34, that is, the motors, to make the vacuum cleaner 11 (the main casing 20) travel autonomously, a charging mode for charging the secondary battery 29 via the charging device 12, and a standby mode applied during a standby state.

The travel control part is configured to control the operation of the motors of the traveling part 21. That is, the travel control part controls the magnitude and the direction of the current flowing through the motors to rotate the motors in a normal or reverse direction to control the operation of the motors, and by controlling the operation of the motors, controls the operation of the driving wheels 34.

The cleaning control part controls the operation of the electric blower 40, the brush motor and the side brush motors of the cleaning unit 22. That is, the cleaning control part controls each of the current-carrying quantities of the electric blower 40, the brush motor and the side brush motors individually, thereby controlling the operation of the electric blower 40, the brush motor (the rotary brush 41) and the side brush motors (the side brushes 43).

The sensor connection part is configured to acquire the detection result by the sensor part 25.

The processing connection part is configured to acquire the setting result set on the basis of the image processing by the image processing part 27.

The input/output connection part is configured to acquire a control command via the input/output part 28 and to output a signal to be output by the input/output part 28 to the input/output part 28.

The image processing part 27 is configured to perform image processing to the images (the original images) captured by the cameras 51. More specifically, the image processing part 27 is configured to extract feature points by the image processing from the images captured by the cameras 51 to detect a distance to an obstacle and a height thereof, and thereby generate the map of the cleaning area, and estimate the current position of the vacuum cleaner 11 (the main casing 20). The image processing part 27 is, for example, an image processing engine including a CPU corresponding to an image processing means main body (an image processing part main body), a ROM, and a RAM or the like. The image processing part 27 includes a camera control part not shown, which controls the operation of the cameras 51. The image processing part 27 further includes an illumination control part not shown, which controls the operation of the lamp 53. Accordingly, the image processing part 27 is electrically connected to the image capturing part 24. The image processing part 27 further includes a memory 61 serving as storage means (a storage section). That is, the vacuum cleaner 11 includes the memory 61. The image processing part 27 includes an image correction part 62 for generating corrected images obtained by correcting the original images captured by the cameras 51. That is, the vacuum cleaner 11 includes the image correction part 62. The image processing part 27 further includes a distance calculation part 63 serving as distance calculation means for calculating a distance to an object positioned in the traveling direction side on the basis of the images. That is, the vacuum cleaner 11 includes the distance calculation part serving as distance calculation means. The image processing part 27 further includes an obstacle detection part 64 serving as obstacle detection means for determining an obstacle on the basis of the calculated distance to an object by the distance calculation part 63. That is, the vacuum cleaner 11 includes the obstacle detection part 64 serving as obstacle detection means. The image processing part 27 further includes a self-position estimation part 65 serving as self-position estimation means for estimating the self-position of the vacuum cleaner 11 (the main casing 20). That is, the vacuum cleaner 11 includes the self-position estimation part 65 serving as self-position estimation means. The image processing part 27 further includes a mapping part 66 serving as mapping means for generating the map of the cleaning area corresponding to the traveling area. That is, the vacuum cleaner 11 includes the mapping part 66 serving as mapping means. The image processing part 27 further includes a traveling plan setting part 67 serving as traveling plan setting means for setting a traveling plan (a traveling route) of the vacuum cleaner 11 (the main casing 20). That is, the vacuum cleaner 11 includes the traveling plan setting part 67 serving as traveling plan setting means.

The camera control part includes a control circuit for controlling, for example, the operation of the shutters of the cameras 51. The camera control part operates the shutters at a specified time interval, thereby controlling the cameras 51 to capture images at a specified time interval.

The illumination control part controls turning-on and turning-off of the lamp 53 via, for example, a switch or the like.

It is noted that the camera control part and the illumination control part may be configured as a device of camera control means which is separate from the image processing part 27, or alternatively, may be disposed in, for example, the control unit 26.

The memory 61 stores various types of data, such as image data captured by the cameras 51 and the map generated by the mapping part 66. A non-volatile memory, for example, a flash memory, serves as the memory 61, which retains the various types of stored data regardless of whether the vacuum cleaner 11 is powered on or off.

The image correction part 62 performs primary image processing to the original images captured by the cameras 51, such as correcting distortion of the lenses, noise reduction, contrast adjusting, and matching the centers of images or the like.

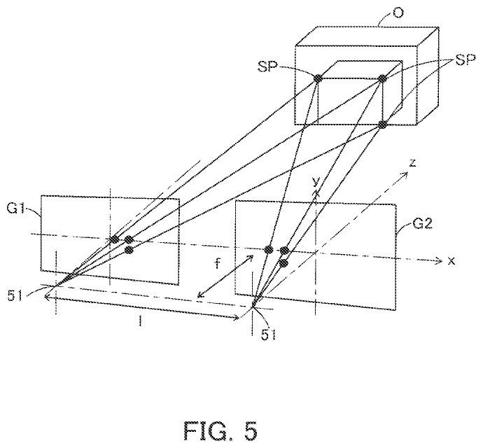

The distance calculation part 63 calculates a distance (depth) of an object (feature points) and the three-dimensional coordinates thereof by a known method on the basis of the images captured by the cameras 51, which in the present embodiment are the corrected images captured by the cameras 51 and corrected thereafter by the image correction part 62, as well as the distance between the cameras 51. That is, as shown in FIG. 5, the distance calculation part 63 applies triangulation based on, for example, a depth f of the cameras 51, a distance (parallax) from the cameras 51 to an object (feature points) of an image G1 and an image G2 captured by the cameras 51, and a distance I between the cameras 51, to detect pixel dots indicative of identical positions in each of the images (the corrected images processed by the image correction part 62 (FIG. 1)) captured by the cameras 51, and to calculate angles of the pixel dots in the up-and-down direction, the left-and-right direction and the back-and-forth direction, thereby calculating a height and a distance of the positions from the cameras 51 on the basis of these angles and the distance between the cameras 51, while also calculating the three-dimensional coordinate of the object O (feature points SP). Therefore, it is preferable that, in the present embodiment, the ranges of the images captured by the plurality of cameras 51 overlap with each other as much as possible. It is noted that the distance calculation part 63 shown in FIG. 1 may generate the distance image (the parallax image) indicating the calculated distance of the object. The distance image is generated by displaying each of the calculated pixel-dot-basis distances by converting them into visually discernible gradation levels such as brightness, color tone or the like on a specified dot basis such as one-dot basis or the like. Accordingly, the distance image is obtained by, as it were, visualizing a mass of distance information (distance data) on the objects positioned within the range captured by the cameras 51 in the forward direction of the traveling direction of the vacuum cleaner 11 (the main casing 20) shown in FIG. 2. It is noted that the feature points can be extracted by performing, for example, edge detection or the like with respect to the image corrected by the image correction part 62 shown in FIG. 1 or the distance image. Any known method can be used as the edge detection method.

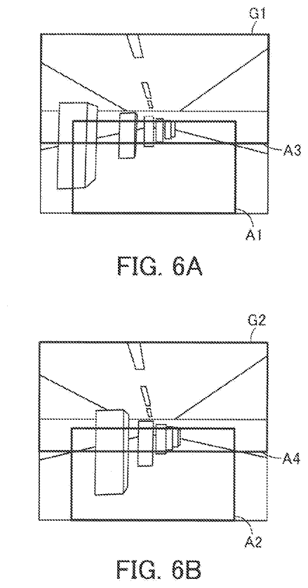

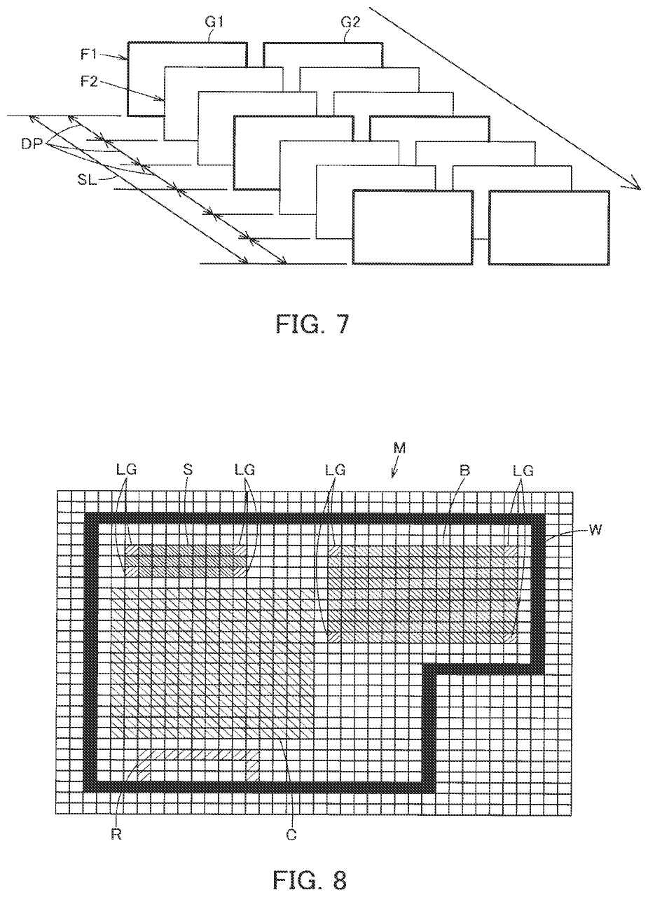

The obstacle detection part 64 detects an obstacle on the basis of the image data captured by the cameras 51. More specifically, the obstacle detection part 64 determines whether or not the object subjected to the calculation of a distance by the distance calculation part 63 would be an obstacle. That is, the obstacle detection part 64 extracts a part of a specified range of the image on the basis of the distance of the object calculated by the distance calculation part 63, and compares the distance of the captured object in the range of the image with a set distance corresponding to a threshold value previously set or variably set, thereby determining objects positioned away by the set distance (the distance from the vacuum cleaner 11 (the main casing 20 (FIG. 2))) or shorter as obstacles (depth processing). The range of the image described above is set according to, for example, the vertical and lateral sizes of the vacuum cleaner 11 (the main casing 20) shown in FIG. 2. That is, the vertical and lateral sizes of the range of the image herein are set to the range with which the vacuum cleaner 11 (the main casing 20) comes into contact when traveling straight. In an example, the range of the image is set to specified ranges A1, A2 which correspond to lower parts in the data of an image G1 and an image G2 shown in FIG. 6(a) and FIG. 6(b). In other words, the range of the image is set to the range through which the vacuum cleaner 11 (the main casing 20 (FIG. 2)) passes when traveling straight. In more detail, the range of the image is set to the specified ranges A1, A2 which, in the image data captured by the cameras 51 (FIG. 1), correspond to the lower parts in the up-and-down direction and is centered around the central parts in the widthwise direction. The data on the specified ranges A1, A2 is used to execute obstacle detection processing. In the present embodiment, in an example, the obstacle detection part 64 shown in FIG. 1 executes the obstacle detection processing (depth processing DP) for each frame of the images G1, G2 captured by the cameras 51 (FIG. 1), as shown in FIG. 7. That is, the obstacle detection processing by the obstacle detection part 64 shown in FIG. 1 is executed substantially in real time at all times.

The self-position estimation part 65 is configured to determine the self-position of the vacuum cleaner 11 and whether or not any object corresponding to an obstacle exists, on the basis of the three-dimensional coordinates of the feature points of the object calculated by the distance calculation part 63. The mapping part 66 generates the map indicating the positional relation and the heights of objects (obstacles) or the like positioned in the cleaning area in which the vacuum cleaner 11 (the main casing 20 (FIG. 2)) is located, on the basis of the three-dimensional coordinates of the feature points calculated by the distance calculation part 63. That is, for the self-position estimation part 65 and the mapping part 66, the known technology of simultaneous localization and mapping (SLAM) can be used.

The mapping part 66 is configured to generate the map of the traveling area on the basis of the images captured by the cameras 51, the position of the vacuum cleaner 11 (the main casing 20) estimated by the self-position estimation part 65, and the obstacle detected by the obstacle detection part 64. Specifically, the mapping part 66 is configured to generate the map of the traveling area by use of three-dimensional data based on the calculation results by the distance calculation part 63 and the self-position estimation part 65, as well as the detection result by the obstacle detection part 64. The mapping part 66 generates a base map by use of any method on the basis of the images captured by the cameras 51, that is, the three-dimensional data on the objects calculated by the distance calculation part 63, and further generates the map of the traveling area by reflecting on the base map the position of the obstacle detected by the obstacle detection part 64. That is, the map data includes three-dimensional data, that is, the two-dimensional arrangement position data and the height data of objects. The map data may further include traveling track data indicating the traveling track of the vacuum cleaner 11 (the main casing (FIG. 2)) during the cleaning.

The self-position estimation processing to be executed by the self-position estimation part 65 and the base map generation processing to be executed by the mapping part 66 (the two types of processing are collectively referred to as SLAM processing) are executed by use of the image data identical to the data used in the obstacle detection processing to be executed by the obstacle detection part 64. In more detail, the self-position estimation processing to be executed by the self-position estimation part 65 and the base map generation processing to be executed by the mapping part 66 are executed by use of the data of the ranges which are respectively set to correspond to those in the image data identical to the data used in the obstacle detection processing to be executed by the obstacle detection part 64. Specifically, the self-position estimation processing to be executed by the self-position estimation part 65 and the base map generation processing to be executed by the mapping part 66 are executed by use of the data of specified ranges A3, A4 (the specified ranges different from the specified ranges A1, A2) which are upper parts in the images G1, G2 shown in FIG. 6(a) and FIG. 6(b). In the present embodiment, each of the set specified rages A3, A4 has a larger width than the specified ranges A1, A2. The frequency in execution of the self-position estimation processing by the self-position estimation part 65 shown in FIG. 1 and the base map generation processing by the mapping part 66 differs from the frequency in execution of the processing by the obstacle detection part 64. In more detail, the frequency in execution of the obstacle detection processing by the obstacle detection part 64 is set higher than the frequency in execution of the self-position estimation processing by the self-position estimation part 65 and the base map generation processing by the mapping part 66. In the present embodiment, the self-position estimation processing by the self-position estimation part 65 and the base map generation processing by the mapping part 66 are executed simultaneously. Specifically, the obstacle detection part 64 executes the obstacle detection processing (depth processing DP) for each frame of the images G1, G2 captured by the cameras 51 (FIG. 7), while the self-position estimation part 65 and the mapping part 66 respectively execute the self-position estimation processing and the base map generation processing (SLAM processing SL) for every plural frames (for example, for every three frames (every third frame) in the present embodiment) (FIG. 7). Accordingly, a timing in which the above-described three types of processing are executed simultaneously (a frame F1 (FIG. 7)), as well as a timing in which only the obstacle detection processing by the obstacle detection part 64 is executed (a frame F2 (FIG. 7)), are set. It is noted that the mapping part 66 may execute the map generation processing to reflect the position of an obstacle on the base map simultaneously at the timing of the obstacle detection processing by the obstacle detection part 64, or alternatively, may execute the map generation processing at timing different from that of the obstacle detection processing.

The traveling plan setting part 67 sets the optimum traveling route on the basis of the map generated by the mapping part 66 and the self-position estimated by the self-position estimation part 65. As the optimum traveling route to be generated herein, a route which can provide efficient traveling (cleaning) is set, such as the route which can provide the shortest traveling distance for traveling in an area possible to be cleaned in the map (an area excluding a part where traveling is impossible due to an obstacle, a step gap or the like), for example, the route where the vacuum cleaner 11 (the main casing 20 (FIG. 2)) travels straight as long as possible (where directional change is least required), the route where contact with an object as an obstacle is less, or the route where the number of times of redundantly traveling the same location is the minimum, or the like. It is noted that, in the present embodiment, the traveling route set by the traveling plan setting part 67 refers to the data (traveling route data) developed in the memory 61 or the like.

The input/output part 28 is configured to acquire a control command transmitted by an external device such as a remote controller not shown, and/or a control command input through input means such as a switch, a touch panel, or the like disposed on the main casing 20 (FIG. 2), and also transmit a signal to, for example, the charging device 12 (FIG. 2). The input/output part 28 includes transmission means (a transmission part) not shown, such as an infrared light emitting element or the like for transmitting wireless signals (infrared signals) to, for example, the charging device 12 (FIG. 2) or the like. Further, the input/output part 28 includes reception means (a reception part) or the like not shown, such as a phototransistor or the like for receiving wireless signals (infrared signals) from the charging device (FIG. 2), a remote controller, or the like.

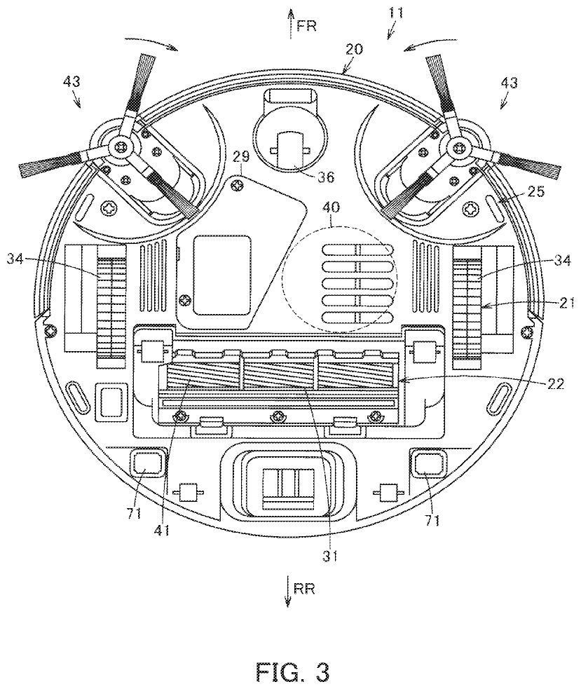

The secondary battery 29 is configured to supply electric power to the traveling part 21, the cleaning unit 22, the data communication part 23, the image capturing part 24, the sensor part 25, the control unit 26, the image processing part 27, and the input/output part 28 or the like. The secondary battery 29 is electrically connected to charging terminals 71 (FIG. 3) serving as connection parts exposed at the lower portions of the main casing 20 (FIG. 2), as an example, and by electrically and mechanically connecting the charging terminals 71 (FIG. 3) to the side of the charging device 12 (FIG. 2), the secondary battery 29 is charged via the charging device 12 (FIG. 2).

The charging device 12 shown in FIG. 2 incorporates a charging circuit, such as a constant current circuit or the like. The charging device 12 includes terminals for charging 73 to be used to charge the secondary battery 29 (FIG. 1). The terminals for charging 73 are electrically connected to the charging circuit and are configured to be mechanically and electrically connected to the charging terminals 71 (FIG. 3) of the vacuum cleaner 11 which has returned to the charging device 12.

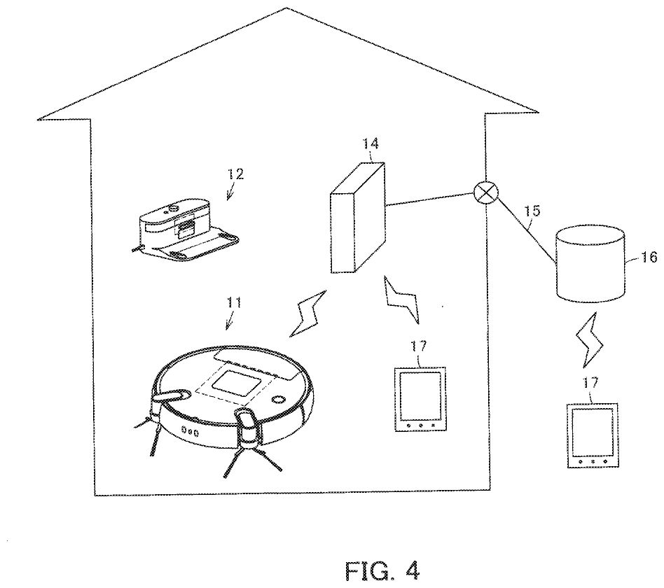

The home gateway 14 shown in FIG. 4, which is also called an access point or the like, is disposed inside a building so as to be connected to the network 15 by, for example, wire.

The server 16, which is a computer (a cloud server) connected to the network 15, is capable of storing various types of data.

The external device 17 is a general-purpose device, such as a PC (a tablet terminal (a tablet PC)), a smartphone (a mobile phone), or the like, which is capable of performing wired or wireless communication with the network 15 via, for example, the home gateway 14 inside a building, and performing wired or wireless communication with the network 15 outside a building. The external device 17 has a display function for displaying at least an image.

The operation of the above-described first embodiment is described below with reference to the drawings.

In general, the work of the vacuum cleaning apparatus is roughly divided into cleaning work for carrying out cleaning by the vacuum cleaner 11, and charging work for charging the secondary battery 29 with the charging device 12. The charging work is implemented by a known method using the charging circuit incorporated in the charging device 12. Accordingly, only the cleaning work will be described. Also, image capturing work for capturing images of a specified object by the cameras 51 in response to an instruction issued by the external device 17 or the like may be included separately.

The outline from the start to the end of the cleaning is described first. The vacuum cleaner 11 undocks from the charging device 12 when starting the cleaning. In the case where the map is not stored in the memory 61, the mapping part 66 generates the map on the basis of the images captured by the cameras 51, and thereafter, the cleaning unit 22 performs the cleaning while the control unit 26 controls the vacuum cleaner 11 (the main casing 20) to travel along the traveling route set by the traveling plan setting part 67 on the basis of the map. In the case where the map is stored in the memory 61, the cleaning unit 22 performs the cleaning while the control unit 26 controls the vacuum cleaner 11 (the main casing 20) to travel along the traveling route set by the traveling plan setting part 67 on the basis of the map. During the cleaning, the mapping part 66 detects the two-dimensional arrangement position and the height of an object on the basis of the images captured by the cameras 51, reflects the detected result on the map, and stores the map in the memory 61. After the cleaning is finished, the control unit 26 performs travel control so as to make the vacuum cleaner 11 (the main casing 20) return to the charging device 12, and after the vacuum cleaner 11 returns to the charging device 12, the control unit 26 is switched over to the charging work for charging the secondary battery 29 at specified timing.

In more detail, in the vacuum cleaner 11, the control unit 26 is switched over from the standby mode to the traveling mode at a certain timing, such as when a preset cleaning start time arrives, when the input/output part 28 receives a control command to start the cleaning which is transmitted by a remote controller or the external device 17, or the like, and thereafter, the control unit 26 (the travel control part) drives the motors (the driving wheels 34) to make the vacuum cleaner 11 undock and move from the charging device 12 by a specified distance.

The vacuum cleaner 11 then determines whether or not the map is stored in the memory 61 by referring to the memory 61. In the case where the map is not stored in the memory 61, the mapping part 66 generates the map of the cleaning area while the vacuum cleaner 11 (the main casing 20) is made to travel (for example, turn) and on the basis of the generated map, the traveling plan setting part 67 generates the optimum traveling route. After the generation of the map of the entire cleaning area, the control unit 26 is switched over to the cleaning mode to be described below.

Meanwhile, in the case where the map is stored in the memory 61 in advance, the traveling plan setting part 67 generates the optimum traveling route on the basis of the map stored in the memory 61, without generating the map.

Then, the vacuum cleaner 11 performs the cleaning while autonomously traveling in the cleaning area along the traveling route generated by the traveling plan setting part 67 (cleaning mode). In the cleaning mode, for example, the electric blower 40, the brush motor (the rotary brush 41) or the side brush motors (the side brushes 43) of the cleaning unit 22 is driven by the control unit 26 (the cleaning control part) to collect dust and dirt on the floor surface into the dust-collecting unit through the suction port 31.

In overview, during the autonomous traveling, the vacuum cleaner 11 repeats the operation of: operating the cleaning unit 22 while advancing along the traveling route, capturing the images of the forward direction in the advancing direction by the cameras 51, detecting an object that would be an obstacle by the obstacle detection part 64 while sensing the surrounding thereof by the sensor part 25, and periodically estimating its self-position by the self-position estimation part 65. During this, the mapping part 66 reflects the detailed information (height data) on the feature points and objects that would be obstacles on the map on the basis of the images captured by the cameras 51, thereby completing the map. Further, the self-position estimation part 65 estimates the self-position of the vacuum cleaner 11 (the main casing 20), whereby the data on the traveling track of the vacuum cleaner 11 (the main casing 20) can also be generated.

At this time, according to the one embodiment described above, a timing in which only either of the processing by the self-position estimation part 65 or the processing by the obstacle detection part 64 is executed, as well as a timing in which both types of processing are executed simultaneously, are set. Accordingly, in comparison with the case where the both types of processing are executed simultaneously all the time, since the load of the image processing executed by the image processing part 27 can be reduced while the vacuum cleaner 11 (the main casing 20) autonomously travels and simultaneously detects an obstacle along the generated map, secure autonomous traveling is enabled.

Since each type of processing by the self-position estimation part 65 and the obstacle detection part 64 are executed by use of the identical image data captured by the cameras 51, the image data is not required to be acquired in each type of processing, and thus, the acquisition of the image data takes a shorter period of time, thereby enabling to realize processing at high speed.

Specifically, each type of processing to be executed by the self-position estimation part 65 and the obstacle detection part 64 are executed by use of the data of the ranges set to correspond to respective parts in the identical image data captured by the cameras 51, whereby the respective processing ranges of the image data are separated in the identical image data. The usage of the data only in the data range required in each processing enables to reduce the number of data, and thus allows the execution of the processing at high speed.

In more detail, the self-position estimation part 65 (and the mapping part 66 for performing the base map generation processing) executes the processing by use of the data corresponding to the upper part in the image data captured by the cameras 51, whereby feature points can be extracted from, for example, legs of a table or a bed, a wall, a ceiling, a shelf, furniture or the like. The obstacle detection part 64 executes the processing by use of the data corresponding to the lower part in the image data, thereby enabling the determination of whether or not an object would be an obstacle to traveling exists in the range corresponding to the size of the vacuum cleaner 11 (the main casing 20).

That is, the obstacle detection part 64 executes the processing by use of the data on the specified ranges A1, A2 which, in the image data captured by the cameras 51, correspond to the lower parts in the up-and-down direction and is centered around the central parts in the widthwise direction, thereby enabling the use of sufficient image data for determining whether or not any object that would be an obstacle to traveling exists in the ranges corresponding to the size of the vacuum cleaner 11 (the main casing 20) when advancing. This enables to execute the processing at higher speed while ensuring the detection of an object that would be an obstacle to traveling.

By differentiating the frequency in execution of the processing by the self-position estimation part 65 from the frequency in execution of the processing by the obstacle detection part 64, the load of the image processing by the image processing part 27 can be reduced in comparison with the case where these types of processing are executed at an identical frequency.

Specifically, by setting the frequency in execution of the processing by the obstacle detection part 64 higher than the frequency in execution of the processing by the self-position estimation part 65, the obstacle detection processing in which an obstacle in traveling needs to be detected one by one is executed frequently so that an obstacle is surely detected during the traveling, while the map generation processing, the traveling track grasping processing or the like which may be executed relatively-less frequently is executed at a lower frequency, thereby enabling to reduce the load of the image processing by the image processing part 27.

That is, since the obstacle detection processing by the obstacle detection part 64 which needs to be executed at a sufficiently-high frequency is executed for each frame while the self-position estimation processing by the self-position estimation part 65 and the base map generation processing by the mapping part 66 each which may be executed at a lower frequency are executed for every plural frames, the load of the image processing can be reduced while effectively utilizing the function of the image processing part 27.

Also, since the self-position estimation processing to be executed by the self-position estimation part 65 and the base map generation processing to be executed by the mapping part 66 are executed by use of data in an identical range, the load of the image processing by the image processing part 27 is prevented from increasing more than necessary, even at the time of simultaneous execution.

As a result, the image processing part 27 (a processor) which requires high-speed processing will be unnecessary, and the image processing part 27 which is a product of relatively-low price can be used to execute each type of processing described above, thereby enabling the realization of the vacuum cleaner 11 having an inexpensive configuration.

After completing the traveling along the set traveling route, the vacuum cleaner 11 returns to the charging device 12, and the control unit 26 is switched over from the traveling mode to the charging mode for charging the secondary battery 29 at specified timings such as right after the returning, when a preset period of time elapses after the returning, when a preset time arrives, or the like.

It is noted that a completed map M is, as visually shown in FIG. 8, stored with a cleaning area (a room) divided into meshes of quadrilateral shapes (square shapes) or the like each having a specified size and with height data associated to each mesh. The height of an object is acquired by the distance calculation part 63 on the basis of the images captured by the cameras 51. In an example, the map M shown in FIG. 8 has a carpet C which is an obstacle causing convex step gaps on a floor surface, a bed B which is an obstacle having a height allowing the vacuum cleaner 11 (the main casing 20) to enter underneath, a sofa S which is an obstacle having a height that allows the vacuum cleaner 11 (the main casing 20) to enter underneath, a shelf R which is an obstacle that does not allow the vacuum cleaner 11 (the main casing 20) to travel, leg parts LG which are obstacles of the bed B and the sofa S, and a wall W which is an obstacle that surrounds the cleaning area and does not allow the vacuum cleaner 11 (the main casing 20) to travel, or the like. The data on the map M is not only stored in the memory 61, but also may be transmitted to the server 16 via the data communication part 23 and the network 15 to be stored in the server 16, or be transmitted to the external device 17 to be stored in a memory of the external device 17.

It is noted that, although in the one embodiment described above, the distance calculation part 63 calculated the three-dimensional coordinates of feature points by use of the images respectively captured by the plurality (the pair) of cameras 51, the three-dimensional coordinates of feature points may alternatively be calculated by use of the plurality of images captured by, for example, one camera 51 in a time division manner while the main casing 20 is traveling.

Further, as long as the timing in which either of the processing by the self-position estimation part 65 or the processing by the obstacle detection part 64 is executed, as well as the timing when the both are executed simultaneously, are set, the timings may be at any given time.

Further, the execution of the self-position estimation processing by the self-position estimation part 65 and the base map generation processing by the mapping part 66 are not limited to be simultaneous, and the two types of processing may be executed at different timings, respectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1. A vacuum cleaner comprising:
a main body;
a travel driving part configured to allow the main body to travel;
a controller configured to make the main body travel autonomously by controlling driving of the travel driving part;
a camera configured to capture an image in a traveling direction side of the main body;
a self-position estimation part configured to estimate a position of the main body on a basis of the image captured by the camera;
an obstacle detection part configured to detect an obstacle on a basis of the image captured by the camera; and
a mapper configured to generate a map of a traveling area, on a basis of the image captured by the camera, the position of the main body estimated by the self-position estimation part, and the obstacle detected by the obstacle detection part, wherein
a timing in which either of each processing by the self-position estimation part or the obstacle detection part is executed during the main body's travelling, as well as a timing in which both types of the processing are simultaneously executed during the same, are set.

2. The vacuum cleaner according to claim 1, wherein
each of the processing by the self-position estimation part and the processing by the obstacle detection part are executed by use of identical image data captured by the camera.

3. The vacuum cleaner according to claim 2, wherein
each of the processing by the self-position estimation part and the processing by the obstacle detection part are executed by use of data of ranges set to correspond to respective parts in the identical image data captured by the camera.

4. The vacuum cleaner according to claim 3, wherein
the self-position estimation part executes the processing by use of data corresponding to an upper part in the image data captured by the camera, and
the obstacle detection part executes the processing by use of data corresponding to a lower part in the image data.

5. The vacuum cleaner according to claim 4, wherein
the obstacle detection part executes the processing by use of data on a specified range which, in the image data captured by the camera, corresponds to a lower part in an up-and-down direction and is centered around a central part in a widthwise direction.

6. The vacuum cleaner according to claim 1, wherein
a frequency in execution of the processing by the self-position estimation part differs from a frequency in execution of the processing by the obstacle detection part.

7. The vacuum cleaner according to claim 6, wherein
the frequency in the execution of the processing by the obstacle detection part is higher than the frequency in the execution of the processing by the self-position estimation part.
